(19) United States
(12) Patent Application Publication
(10) Pub. No.: US 2020/0198781 A1
(43) Pub. Date: Jun. 25, 2020

(54) DUCT WITH INCREASED THRUST

(71) Applicant: Bell Helicopter Textron Inc., Fort Worth, TX (US)

(72) Inventors: Andrew Paul Haldeman, Fort Worth, TX (US); Frank Bradley Stamps, Colleyville, TX (US); John Lloyd, Arlington, TX (US); Aaron Alexander Acee, Flower Mound, TX (US); Dalton T. Hampton, Fort Worth, TX (US); Albert Gerard Brand, North Richland Hills, TX (US)

(73) Assignee: Bell Helicopter Textron Inc., Fort Worth, TX (US)

(21) Appl. No.: 16/231,524

(22) Filed: Dec. 23, 2018

(51) Int. Cl. B64C 27/82

(52) U.S. Cl. CPC B64C 27/82; B64C 2027/8227; B64C 2027/8254; B64C 2027/8281; B64C 2027/8245

(57) ABSTRACT

A duct configured with a fan to increase thrust. The duct includes an interior surface configured to surround a rotation axis of the fan. The interior surface includes a nozzle portion configured to be located upstream of the fan and a diffuser portion configured to be located downstream of the fan. The interior surface defines an opening configured to introduce additional airflow along the diffuser portion.

### BACKGROUND

Placing a fan inside a duct can result in a system that produces more thrust for the same power. This increase in thrust is produced because the shape of the duct allows the duct to carry a thrust force. In order to maximize efficiency, ducts typically include an expanding conical diffuser section that serves to slow down the exit velocity, which returns the flow to atmospheric pressure. The diffuser divergence angle is limited by the need to prevent boundary layer separation of the airflow from the duct surface. This limited diffuser angle requires a longer length of the diffuser section to return the airflow to atmospheric pressure.

Aircraft do not generally include ducts around propellers or proprotors because the benefit of the increased thrust/power is often outweighed by the drag caused by the duct and the additional weight of the duct itself. However, if the amount of thrust provided could be sufficiently increased, and/or the size and weight of the duct could be sufficiently reduced, the use of a ducted propeller or proprotor may be justified. Because helicopter tail rotors produce thrust in a direction that is orthogonal to the primary direction of travel, the tail rotor may be placed within the vertical tail section of the helicopter itself, and therefore, ducted tail rotors may not substantially increase the drag of the helicopter in forward flight. However, increasing the thrust produced by a given sized fan would enable the use of smaller, lighter ducted tail rotors. Moreover, in order to limit the drag caused by the width of the vertical tail section during forward flight, helicopters with ducted tail rotors often limit the length of the diffuser section to a less than optimal length. Accordingly, it would be beneficial to have a ducted tail rotor system capable of returning the airflow to atmospheric pressure in a shorter diffuser section.

### BRIEF DESCRIPTION OF THE DRAWINGS

FIG. 1 is a side view of a helicopter with ducted tail rotors, according to this disclosure.

FIG. 2 is a cross-sectional side view of one of the ducted tail rotors of FIG. 1.

FIG. 3 is a front view of a helicopter with ducted propellers, according to this disclosure.

FIG. 4 is a top view of the helicopter of FIG. 3.

FIG. 5 is an oblique view of another helicopter with a ducted tail rotor, according to this disclosure.

FIG. 6 is a cross-sectional view of a tail boom of the helicopter of FIG. 5.

### DETAILED DESCRIPTION

While the making and using of various embodiments of this disclosure are discussed in detail below, it should be appreciated that this disclosure provides many applicable inventive concepts, which can be embodied in a wide variety of specific contexts. The specific embodiments discussed herein are merely illustrative and do not limit the scope of this disclosure. In the interest of clarity, not all features of an actual implementation may be described in this disclosure. It will of course be appreciated that in the development of any such actual embodiment, numerous implementation-specific decisions must be made to achieve the developer's specific goals, such as compliance with system-related and business-related constraints, which will vary from one implementation to another.

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure divulges a duct for improving the thrust capability of a ducted fan arrangement. Currently, duct exits are limited to a maximum diffuser divergence angle. This maximum diffuser divergence angle is determined by the angle at which airflow through the fan separates from the diffuser surface. The duct divulged in this disclosure allows for a greater divergence angle that permits a shorter duct, resulting in less weight and less drag. The duct may utilize a greater divergence angle because the interior surface of the duct includes an opening that introduces additional airflow along the diffuser surface. This additional airflow energizes the boundary layer, thereby facilitating attachment of the airflow through the fan to the diffuser surface at the greater divergence angle.

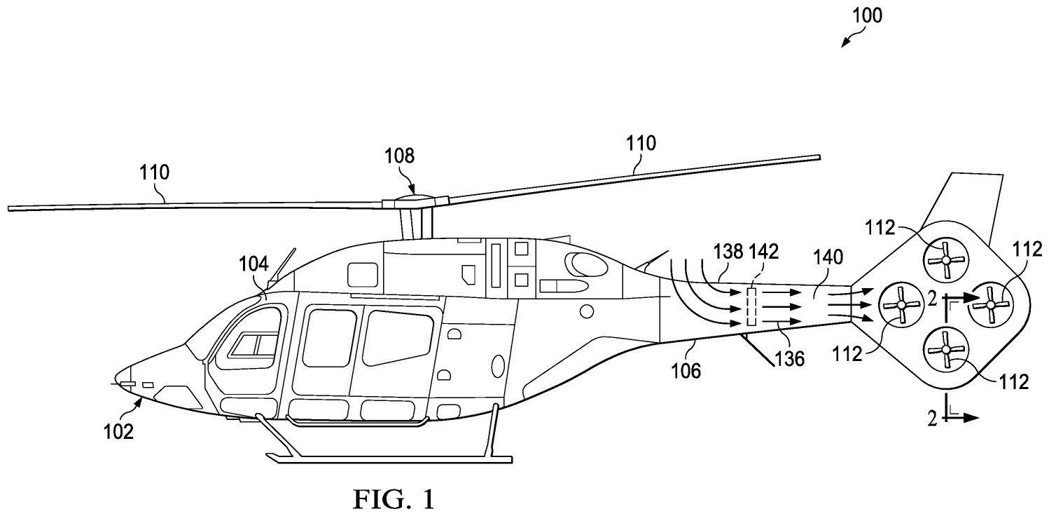

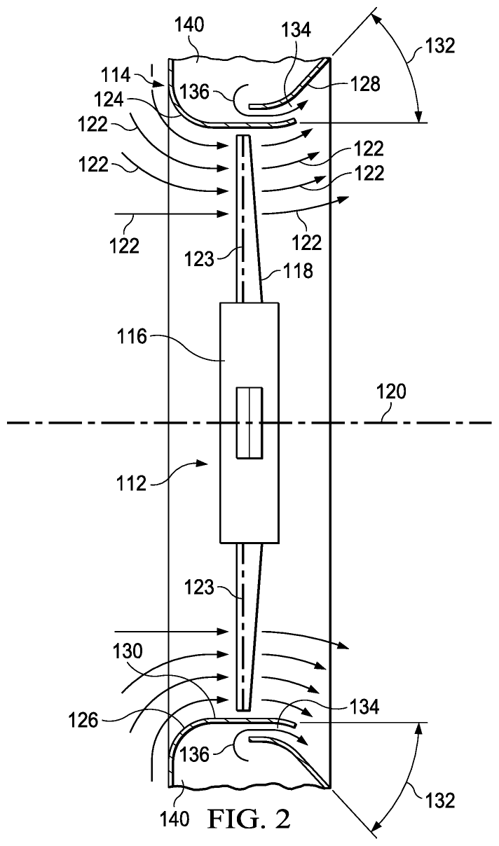

Referring to FIG. 1, a helicopter 100 is illustrated. Helicopter 100 includes a fuselage 102 comprising a body section 104 and a tail boom 106, a main rotor 108 comprising a plurality of main rotor blades 110, and a plurality of tail rotors 112 housed within tail boom 106. FIG. 2 shows a typical cross-section of one of tail rotors 112 and a duct 114 surrounding tail rotor 112. Tail rotor 112 includes a hub 116 with a plurality of tail rotor blades 118 coupled thereto for common rotation about a rotation axis 120, wherein rotation axis 120 is approximately perpendicular to a longitudinal plane generally bisecting helicopter 100. As shown by arrows 122, rotation of tail rotor blades 118 about rotation axis 120 causes air to flow through duct 114 thereby creating thrust along rotation axis 120 in the direction opposite airflow 122. Tail rotor blades 118 may also be rotatable about their pitch change axes 123 to modify the thrust produced by tail rotor 112.

Duct 114 includes an annular interior surface 124 surrounding rotation axis 120. Interior surface 124 includes a nozzle portion 126 located upstream of tail rotor 112, a diffuser portion 128 located downstream of tail rotor 112, and a cylindrical portion 130 located between nozzle portion 126 and diffuser portion 128. Diffuser portion 128 has a generally frustoconical shape with a divergence angle 132 defined as the angle between diffuser portion 128 and rotation axis 120. Interior surface 124 includes an opening 134 extending around the circumference of duct 114 located proximate the transition from cylindrical portion 130 to diffuser portion 128.

Opening 134 is configured to introduce additional airflow 136 along diffuser portion 128 to energize the boundary layer and facilitate attachment of airflow 122 to diffuser portion 128. Accordingly, additional airflow 136 allows divergence angle 132 to be greater than the maximum functional divergence angle that would be possible for a standard duct surrounding an identical tail rotor 112. This greater divergence angle 132 allows for a greater pressure recovery and a greater efficiency of tail rotor 112, and therefore, greater thrust than would be possible for a standard duct surrounding an identical tail rotor 112. Moreover, it enables a length of duct 114 along rotation axis 120 to be shorter than would otherwise be required to return airflow 122 to atmospheric pressure. Thereby allowing for tail boom 106 to be narrower and lighter than previously possible. Divergence angle 132 may be greater than ten degrees. In addition, divergence angle 132 may vary along a length of diffuser portion 128. For example, divergence angle 132 may increase, or decrease, with distance from tail rotor 112. Interior surface 124 may further include a second opening (not shown) downstream of opening 134 configured for the introduction of additional airflow along diffuser portion 128.

As shown in FIG. 1, additional airflow 136 is drawn into an airflow intake 138, located proximate the front end of tail boom 106, and flows through a channel 140, extending through tail boom 106, to openings 134 of each duct 114. Additional airflow 136 is drawn into channel 140 and pressurized by a fan 142 located within channel 140. Helicopter 100 may include pressure sensors within channel 140 to automatically adjust the speed of fan 142 to produce the required additional airflow 136 necessary to maintain the attachment of airflow 122 to the diffuser portion 128. Alternatively, the volume of additional airflow 136 may be altered by pitching fan blades of fan 142. Moreover, helicopter 100 may include flaps located within channel 140 adjacent to openings 134 to control the size of openings 134, and therefore, the velocity/volume of additional airflow 136 flowing through openings 134.

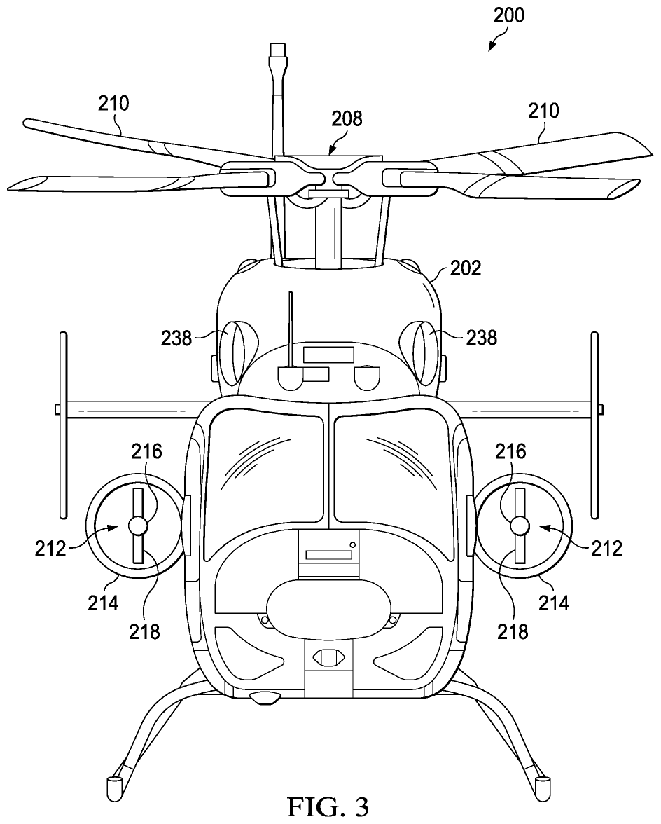

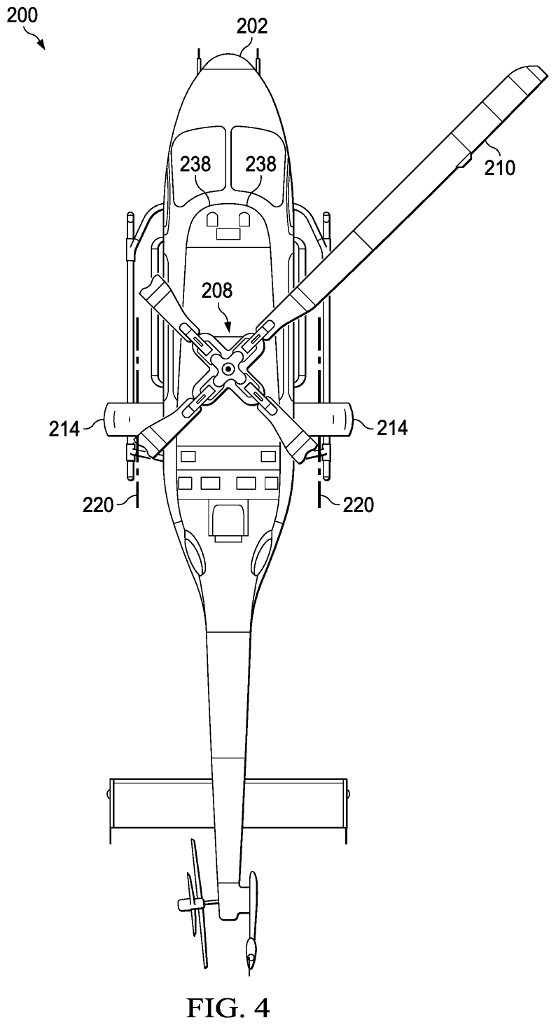

Referring to FIGS. 3 and 4, a helicopter 200 is illustrated. Helicopter 200 includes a fuselage 202, a main rotor 208 comprising a plurality of main rotor blades 210, and a pair of forward-facing propellers 212. Each forward-facing propeller 212 is housed with a duct 214 and includes a hub 216 with a plurality of propeller blades 218 coupled thereto for common rotation about a rotation axis 220, wherein rotation axes 220 are approximately parallel to a longitudinal plane generally bisecting helicopter 200. Similar to tail rotors 112 discussed above, rotation of propeller blades 218 about rotation axis 220 causes air to flow through duct 214 thereby creating thrust along rotation axis 220 in the direction opposite the airflow. Propeller blades 218 may also be rotatable about their pitch change axes to modify the thrust produced by forward-facing propellers 212.

While the structure of ducts 214 is not shown, it should be understood that it is similar to that of ducts 114 discussed above. That is, each duct 214 includes an opening configured to introduce additional airflow along a diffuser portion to energize the boundary layer and facilitate attachment of the airflow passing by forward-facing propeller 212 to the diffuser portion. For each duct 214, the additional airflow is drawn into an airflow intake 238, located proximate the front end of fuselage 202, and flows through a channel that extends from intake 238, through fuselage 202, to the opening of the respective duct 214. The additional airflow is drawn into the channel and pressurized by a fan located within each channel.

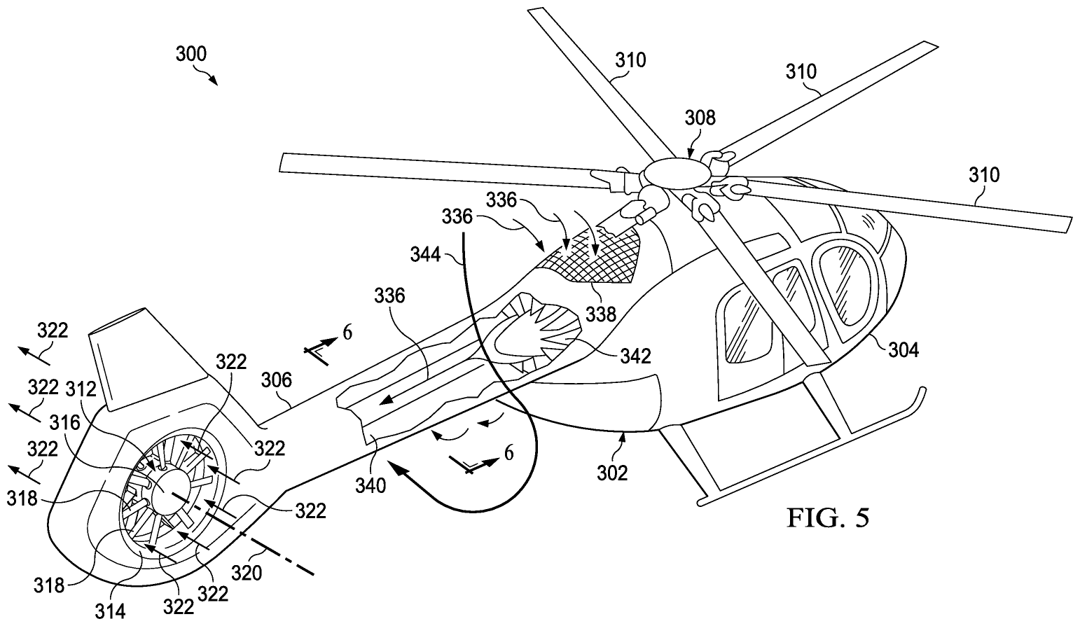

Referring to FIG. 5, a helicopter 300 is illustrated. Helicopter 300 includes a fuselage 302 comprising a body section 304 and a tail boom 306, a main rotor 308 comprising a plurality of main rotor blades 310, and a tail rotor 312 housed within a duct 314 extending through tail boom 306. Similar to tail rotors 112 discussed above, tail rotor 312 includes a hub 316 with a plurality of tail rotor blades 318 coupled thereto for common rotation about a rotation axis 320, wherein rotation axis 320 is approximately perpendicular to a longitudinal plane generally bisecting helicopter 300. As shown by arrows 322, rotation of tail rotor blades 318 about rotation axis 320 causes air to flow through duct 314 thereby creating thrust along rotation axis 320 in the direction opposite airflow 322. Tail rotor blades 318 may also be rotatable about their pitch change axes to modify the thrust produced by tail rotor 312.

While the details of duct 314 are not shown, it should be understood that the structure is similar to that of ducts 114 discussed above. That is, duct 314 includes an opening configured to introduce additional airflow 336 along a diffuser portion to energize the boundary layer and facilitate attachment of airflow 322 passing by tail rotor 312 to the diffuser portion. Additional airflow 336 is drawn into an airflow intake 338, located proximate the tail end of body section 304, and flows through a channel 340, extending through tail boom 306, to the opening of duct 314. Additional airflow 336 is drawn into channel 340 and pressurized by a fan 342 located within channel 340. Helicopter 300 may include pressure sensors within channel 340 to automatically adjust the speed of fan 342, or pitching the blades thereof, to produce the required additional airflow 336 necessary to maintain attachment of the corresponding airflow 322 to the diffuser portion.

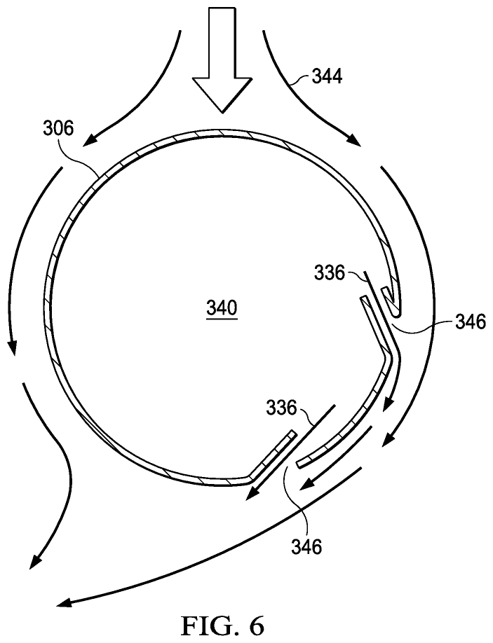

Helicopter 300 is also configured to provide anti-torque thrust by utilizing the Coanda effect on tail boom 306. Normally, the downwash from the main rotor of a helicopter flows evenly around the tail boom. However, as shown in FIG. 6, a cross-sectional view of tail boom 306, the path of downwash 344 from main rotor 308 is altered by the introduction of additional airflow 336 through a pair of slits 346 running along the length of the bottom starboard side of tail boom 306. The introduction of additional airflow 336 energizes the boundary layer on the starboard side of tail boom 306, thereby causing downwash 344 to stay attached to the starboard side of tail boom 306 longer than the port side. This additional attachment to the starboard side of tail boom 306 causes a pressure differential between the starboard and port sides of tail boom 306, and therefore, generates thrust on tail boom 306 in the starboard direction. This starboard thrust serves to partially counteract the torque imparted to fuselage 302 by the rotation of main rotor 308.

While this disclosure describes devices for increased thrust for use as tail rotors and forward-facing propellers on helicopters, it is not so limited. The disclosed devices may be used with any aircraft including fixed-wing airplanes, rotorcraft with fixed ducted rotors, such as those on a quadcopter, or on ducted tiltrotor aircraft. Moreover, the disclosed devices may also be used with any ducted fan arrangement that may benefit from increased efficiency and decreased size and weight.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A duct configured to increase thrust produced by a fan, comprising:
an interior surface configured to surround a rotation axis of the fan, the interior surface comprising:
a nozzle portion configured to be located upstream of the fan; and
a diffuser portion configured to be located downstream of the fan, the diffuser portion having a divergence angle defined as an angle between the diffuser portion and the rotation axis of the fan;
wherein the interior surface defines an opening configured to introduce additional airflow along the diffuser portion.

2. The duct of claim 1, wherein the divergence angle of the diffuser portion is greater than ten degrees.

3. The duct of claim 1, wherein the divergence angle varies along a length of the diffuser portion.

4. The duct of claim 1, wherein the opening extends around a circumference of the interior surface of the duct.

5. The duct of claim 4, wherein the interior surface further includes a cylindrical portion between the nozzle portion and the diffuser portion.

6. The duct of claim 1, wherein the interior surface further defines a second opening downstream of the opening.

7. A device for producing thrust, comprising:
a fan configured to rotate about a rotation axis;
a duct surrounding the fan, the duct comprising:
an interior surface facing the rotation axis, comprising:
a nozzle portion located upstream of the fan; and
a diffuser portion located downstream of the fan, the diffuser portion having a divergence angle defined as an angle between the diffuser portion and the rotation axis of the fan;
wherein the interior surface defines an opening configured to introduce additional airflow along the diffuser portion; and
a channel extending from the opening in the interior surface of the duct to an airflow intake.

8. The device of claim 7, wherein the airflow intake is remote from the duct.

9. The device of claim 7, further comprising:
a second fan within the channel.

10. The device of claim 7, wherein the opening extends around a circumference of the interior surface of the duct.

11. The device of claim 7, wherein the interior surface further defines a second opening downstream of the opening.

12. The device of claim 7, wherein the divergence angle of the diffuser portion is greater than ten degrees.

13. The device of claim 7, wherein the divergence angle varies along a length of the diffuser portion.

14. The device of claim 13, wherein the divergence angle increases with distance from the fan.

15. An aircraft, comprising:
a fuselage; and
a device for producing thrust, the device comprising:
a fan configured to rotate about a rotation axis;
a duct surrounding the fan, the duct comprising:
an interior surface facing the rotation axis, comprising:
a nozzle portion located upstream of the fan; and
a diffuser portion located downstream of the fan, the diffuser portion having a divergence angle defined as an angle between the diffuser portion and the rotation axis of the fan;
wherein the interior surface defines an opening configured to introduce additional airflow along the diffuser portion; and
a channel extending from the opening in the interior surface of the duct to an airflow intake.

16. The aircraft of claim 15, wherein the rotation axis is approximately parallel to a longitudinal plane generally bisecting the aircraft.

17. The aircraft of claim 15, wherein the rotation axis is approximately perpendicular to a longitudinal plane generally bisecting the aircraft.

18. The aircraft of claim 17, further comprising:
a second fan within the channel.

19. The aircraft of claim 18, further comprising:
a slit extending along a portion of a tail boom, the slit being configured to allow air to flow from the channel to an exterior surface of the tail boom.

20. The aircraft of claim 15, wherein the divergence angle is greater than ten degrees.
